(19) United States
(12) Patent Application Publication
(10) Pub. No.: US 2009/0073172 A1
(43) Pub. Date: Mar. 19, 2009

(54) METHOD AND APPARATUS FOR DISPLAYING OPERATION PATH OF PROCESS

(76) Inventors: Chang Jie Guo, Beijing (CN); Tie Jun Ou, Beijing (CN); Yi Hui, Beijing (CN); Wei Sun, Beijing (CN); Weixin Xu, Union City, CA (US)

Correspondence Address: LAW OFFICE OF IDO TUCHMAN (YOR), ECM #72212, PO Box 4668, New York, NY, 10163-4668, US

(21) Appl. No.: 12/212,588

(22) Filed: Sep. 17, 2008

(30) Foreign Application Priority Data
Sep. 17, 2007 (CN) 200710154262.3

(51) Int. Cl. G06T 11/20

(52) U.S. Cl. 345/440

(57) ABSTRACT

A method, apparatus, computer program product for displaying the operation path of a process. According to the invention, at least two virtual instance views are generated, and the at least two virtual instance views and the relationships therebetween together exhibit the complete operation path containing possible dynamic operations, wherein a virtual instance view corresponds to a virtual instance and a virtual instance is a part of the entire operation path of the process. In each virtual instance view generated, the operation path of the corresponding virtual instance is presented, i.e. its starting node, terminating node and operation paths therebetween. The generated virtual instance views can be displayed in a temporal order and the operation paths between these virtual instances are visually displayed between the adjacent virtual instance views.

### CROSS-REFERENCE TO RELATED APPLICATIONS

This application claims priority under 35 U.S.C. § 119 to Chinese Patent Application No. 200710154262.3 filed Sep. 17, 2007, the entire text of which is specifically incorporated by reference herein.

### TECHNICAL FIELD

The present invention relates generally to tracking and displaying the operation path of a process, and particularly to a method and apparatus for tracking and displaying the operation path of a process containing dynamic operations.

### BACKGROUND OF THE INVENTION

At present, in people's work and life, a flow diagram in the form of a directed graph is usually used to reflect the predetermined course of a process, e.g. a business process, a control process, and the like. Here, the directed graph refers to a graph consisting of a starting node, an end node, intermediate nodes possibly existing between the starting node and the end node, and directed links connected therebetween. FIG. 1 shows the flow diagram of a business process represented in the form of a directed graph, while FIG. 3 shows the flow diagram of a control process represented in the form of a directed graph.

The nodes in the flow diagram of a process in the form of a directed graph can be divided into two types, i.e. work node and judgment node. A work node refers to the one that executes actual operations in the running course of a process, such as Node N11 “Undertaker”, Node N12 “Department Manager in City Sub-company”, Node N14 “Leader of City Sub-company”, Node N15 “Specific Project Management Post”, etc. in FIG. 1, and Node N31 “Turn on Failure Indicating Lamp”, Node N32 “Detect Electromagnetic Valve Failure Signal Feedback Terminal”, and Node N34 “Test Motor Failure Signal Feedback Terminal”, etc. in FIG. 3. As shown in FIG. 1 and FIG. 3, only one operation (i.e. link) is directly connected after a work node in the flow diagrams; for example, the operation from Node N11 to Node N12 is directly connected after Node N11 in FIG. 1. That is to say, in the predetermined course as shown in the flow diagram, the operation executed by a work node is unique.

On the other hand, a judgment node does not perform actual operation, but only judges a certain fact so as to select and determine the subsequent process operation, such as Node N13 “Is Sum Larger than 1,000 thousand?”, Node N17 “Is Sum Larger than 5,000 thousand?” shown in FIG. 1, and Node N33 “Does Electromagnetic Valve Fail?”, Node N35 “Does Motor Fail?” and Node N37 “Is Result Correct?” shown in FIG. 3. As shown in FIG. 1 and FIG. 3, at least two branches (i.e. operations) are directly connected after each judgment node so as to be selected based on the judgment condition; for example, two operations are directly connected after the judgment node N13 in FIG. 1, one from Node N13 to Node N15 and the other from Node N13 to Node N14. All the operations after the judgment nodes shown in the accompanying drawings are forward operations, that is, the direction thereof is consistent with the direction from the starting node to the end node, but those skilled in the art can envisage that the operations after the judgment nodes can also be backward operations, that is, the direction thereof is consistent with the direction from the end node to the starting node.

In the actual running course of a process, a dynamic operation may take place at a node so that the operation path of the process is divided into two operation sub-paths.

The dynamic operation in a process can be a jump from a work node to a certain target node in the flow diagram of the process via a link which is originally absent in the flow diagram, and then starting from the target node, the process further proceeds according to the predetermined course in the flow diagram.

For instance, in the operation path of a business process, there may exist some abrupt and temporary jump operations to reach a certain node in the business flow diagram and then the business process further proceeds according to the predetermined course. FIG. 2 shows, in the flow diagram, the operation path of the business process shown in FIG. 1, wherein the operation links shown by dashed lines represent three jump operations occurring in the running course of the business process shown in FIG. 1. In the running course of a control process, there may also be some abnormal situations, so that the control process cannot proceed in accordance with the predetermined course shown in the flow diagram, but jumps to a certain node via a link absent in the flow diagram and then the control process further proceeds according to the predetermined course. FIG. 4 shows the operation path of the control process shown in FIG. 3, wherein the operation from Node N36 to Node N32 and the operation from Node N34 to Node N38 are two jump operations.

Preferably, in addition to the above dynamic operations at the work nodes, it is also possible to specify one of the operations directly connected after a judgment node as normal operation, and to specify the other(s) as dynamic operation(s). For example, as for the judgment node N13 in FIG. 1, the operation from Node N13 to Node N15 may be specified as normal operation, and the operation from Node N13 to Node N14 is thus dynamic operation.

In the examples described below in detail, a description is only made of the dynamic operations at the work nodes. However, those skilled in the art, based on the following detailed description, can readily apply the method and apparatus of the present invention to the dynamic operations at the judgment nodes.

In addition to representing the predetermined course of a process by using a flow diagram, it is further necessary to track and display the runtime course (i.e. operation path) of the process so that people can track and know the actual running status of the process. A key problem for displaying the operation path of a process lies in how to present dynamic operations of the process in the actual running course. For example, a jump is one important typical dynamic operation. Usually, there may exist one or more jumpable nodes in a process.

In order to display the actual operation path of a process, two methods of displaying the actual running course of a process have been proposed in the prior art.

Herein, one of the methods in the prior art is to depict the actual operation path of a process directly in its directed flow diagram representing the predetermined course. This display method in the prior art is described below by way of the business process shown in FIG. 1.

FIG. 1 shows, by taking a business process as example, an exemplary view of the flow diagram in the form of a directed graph, wherein the following contents are illustrated: a starting node, an end node, and nodes N11 “Undertaker”, N12 “Department Manager in City Sub-company”, N13 “Is Sum larger than 1,000 thousand?”, N14 “Leader of City Sub-company”, N15 “Specific Project Management Post”, N16 “Planning Department Manager in Province Sub-company”, N17 “Is Sum larger than 5,000 Thousand?”, N18 “Leader of Province Sub-company”, N19 “Department Manager in Province Sub-company”, and N20 “Clerk in Province Sub-company”, as well as the directed links therebetween. The flow diagram shown in FIG. 1 illustrates the predetermined (planed) course of the business process.

In the actual running course of the business process, some temporary and abrupt dynamic operations may occur. For example, as shown by dashed lines in FIG. 2, when the business process reaches Node N15 “Specific Project Management Post”, the specific project management post may believe that the current sum of money is insufficient, and then require returning to Node N11 “Undertaker” to increase the sum; when the business process reaches Node N16 “Planning Department Manager in Province Sub-company”, the planning department manager may require returning to Node N15 “Specific Project Management Post” to modify data; when the business process reaches Node N18 “Leader of Province Sub-company”, the leader of province sub-company may require returning to Node N14 “Leader of City Sub-company” to modify data. These dynamic operations in the actual operation path of the business process are not specified and presented in the flow diagram. Thus, information on the actual operation path of the business process cannot be obtained from the flow diagram.

Accordingly, it is necessary to track and present the actual operation path of a process so as to know the actual running course of the process. FIG. 2 shows a display view for tracking and presenting the actual running course of the business process by depicting the actual operation path of the process directly in its flow diagram in the prior art. As shown in FIG. 2, three dynamic operations as above described are directly depicted in the flow diagram shown in FIG. 1 by using dashed lines with arrow, and real lines with arrow are used to represent those operation sub-paths in compliance with the predetermined course of the process in the process operation path. From FIG. 2, it can be seen that the nodes and links before Node N18 “Leader of Province Sub-company” in the flow diagram are passed through plural times and a plurality of sub-paths meet or overlap at these nodes and links and it is necessary to add dynamic links (i.e. the dashed lines in the figure) which originally do not exist in the original flow diagram.

The tracking and presenting result shown in FIG. 2 is a maze, so that it is difficult for users to clearly understand and recognize the operation path, because for example, as above described, the operation path may pass through one same node or link plural times and different sub-paths may often meet or overlap at the nodes or links, and it is further necessary to add jump links in the original directed flow diagram. As a consequence, all of these will cause the resultant view to seem like a maze so that an end user cannot clearly understand the whole operation path. Thus, this method is deficient in providing a concise, clear and intuitive view, especially in a complicated jump circumstance.

The other method in the prior art is to provide a new view to directly list the operation path in a line style. This display method is described below by taking the control process shown in FIG. 3 as example.

FIG. 3 illustrates a control process for the system self-detection, wherein a failure indicating lamp is first lighted (N31), and then an electromagnetic valve failure signal feedback terminal is detected (N32). If the electromagnetic valve fails, a failure information will be added (N39) and the process will return (N40); if the electromagnetic valve does not fail, a motor failure signal feedback terminal will be tested (N34). If a result of the test indicates that the motor fails, a failure information will be added (N39) and then the process will return (N40); if the result of the test indicates that the motor does not fail, the process advances to software module detection (N36). If the detection result of the software module detection is negative, a failure information will be added (N39) and the process will return (N40); if the detection result is positive, the failure indicating lamp will be extinguished (N38) and the process will return (N40).

The flow diagram of the control process shown in FIG. 3 represents the determined course occurring in an ideal normal situation. However, in an actual running course, some abnormal operations, i.e. the operations not shown in the flow diagram of FIG. 3, may occur in the system. For example, due to the failure of some part(s) in the system or for other reasons, the following dynamic operations may occur, as shown in FIG. 4: when the control process proceeds to Node N36 “Software Module Detection”, the control process directly jumps to Node N32 “Detect Electromagnetic Valve Failure Signal Feedback Terminal”; and when the control process proceeds to Node N34 “Test Motor Failure Signal Feedback Terminal”, the control process directly jumps to Node N38 “Extinguish Failure Indicating Lamp”. In order to recognize abnormal operations of the control process in the actual runtime, it is necessary to track the actual operation path of the control process and present to the user the actual operation path of the control process.

In the prior art, the operation path of the control process shown in FIG. 3 can be tracked and displayed by directly listing the actual operation path of the process in a line style. FIG. 4 indicates the actual operation path of the control process in a line style, which includes the dynamic operation from Node N36 to Node N32 and the dynamic operation from Node N34 to Node N38. Clearly, the actual operation path of the control process shown in FIG. 4 only simply lists the operation path of the control process, but fails to intuitively reflect the logic (predetermined course) represented by the flow diagram of FIG. 3 and the relationships among different nodes in the flow diagram, so that the user cannot comprehensively understand the control logic of the control process.

Although this method is capable of clearly representing the whole operation path, it cannot reflect the sequence logic represented by the flow diagram and the jump relationships among different nodes in the flow diagram, that is, the method cannot comprehensively present the predetermined course of the process and the actual operation path thereof. In fact, this method makes the flow diagram become useless and is thus unacceptable.

### BRIEF SUMMARY OF THE INVENTION

An object of the invention is to make an improvement on the method of displaying an operation path in the prior art and to provide a novel method and apparatus for displaying an operation path, thereby overcoming the drawbacks of the method in the prior art.

One object of the invention is to provide a method and apparatus to display an operation path in a more intuitive and clear way.

Another object of the invention is to provide a method and apparatus to display the predetermined course of a process and the actual operation path thereof in a more holistic way.

According to one aspect of the invention, there is provided a method of displaying the operation path of a process, comprising the steps of: a first display step of displaying views of at least two virtual instances of the process in a temporal order, wherein the view of each virtual instance presents at least part of the operation path of the process; and a second display step of visually displaying between the adjacent virtual instance views the operation paths between the at least two virtual instances.

According to another aspect of the invention, there is provided an apparatus for displaying the operation path of a process, comprising: first display means for displaying views of at least two virtual instances of the process in a temporal order, wherein the view of each virtual instance presents at least part of the operation path of the process; and second display means for visually displaying between the adjacent virtual instance views the operation paths between the at least two virtual instances.

According to a further aspect of the invention, there is provided a computer program product comprising program codes stored in a computer readable storage medium, wherein said program codes are used to execute steps of the method.

Other characteristics and advantages of the invention will become obvious in combination with the description of accompanying drawings, wherein the same number represents the same or similar parts in all figures.

### BRIEF DESCRIPTION OF THE SEVERAL VIEWS OF THE DRAWINGS

The figures form a part of the specification and are used to describe the embodiments of the invention and explain the principle of the invention together with the literal statement.

FIG. 1 illustrates, by taking a business process as example, an exemplary view of a flow diagram in the form of a directed graph.

FIG. 2 illustrates, by taking the business process shown in FIG. 1 as example, a view directly depicting the whole operation path in the flow diagram in accordance with the prior art.

FIG. 3 illustrates, by taking a control process as example, another exemplary view of a flow diagram in the form of a directed graph.

FIG. 4 illustrates, by taking the control process shown in FIG. 3 as example, a view directly listing the operation path in a line style according to the prior art.

FIG. 5 illustrates a flow diagram of the method of displaying the operation path of a process according to the present invention;

FIG. 6 illustrates, by taking the business process shown in FIG. 1 as example, the process operation path displayed according to the present invention.

FIG. 7 illustrates a three-dimensional display of the process operation path shown in FIG. 6, wherein all virtual instance views are in a collapsed state.

FIG. 8 illustrates the circumstance in which two foremost virtual instance views in the view of the process operation path shown in FIG. 7 are spread.

FIG. 9 illustrates the process operation path displayed according to the invention by taking, as example, the control process shown in FIG. 3.

FIG. 10 illustrates a three-dimensional display of the process operation path shown in FIG. 9, wherein the second and third virtual instance views are spread.

FIG. 11 is a function block diagram for dynamically displaying the process operation path according to the present invention.

FIG. 12 is a flow diagram of the method for dynamically displaying the process operation path according to the present invention.

FIG. 13 is a view of the process operation path dynamically displayed according to the present invention by taking, as example, the business process shown in FIG. 1.

### DETAILED DESCRIPTION OF THE INVENTION

In order to make the objects, technical solutions and advantages of the invention clearer, the invention is further described below in detail with reference to the preferred embodiments in conjunction with the accompanying drawings.

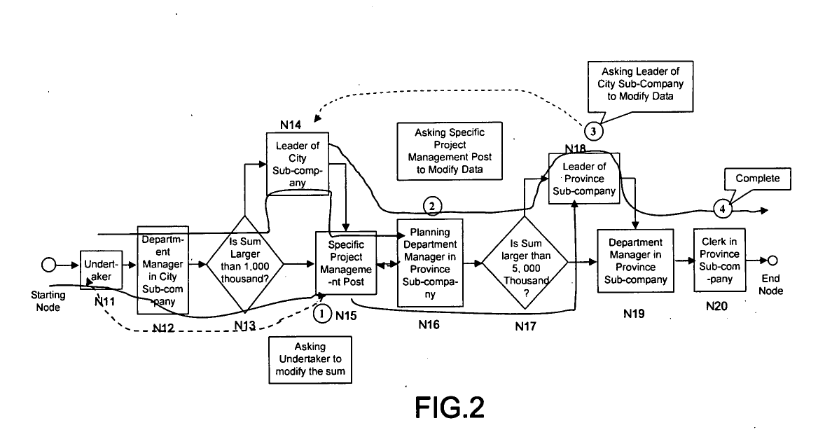

According to the present invention, the complete operation path of a process is not shown in one view, but at least two virtual instance views are generated, and these at least two virtual instance views and the relations between them together show the entire operation path including possible dynamical operations. One virtual instance view corresponds to one virtual instance, while one virtual instance is part of the entire operation path of a process. In each virtual instance view generated, the operation path of the respective virtual instance (i.e. its starting node, terminating node and operation links therebetween) is presented. The virtual instance views generated can be displayed in a temporal order, and between the adjacent virtual instance views, the operation paths between these virtual instances are visually displayed. Presenting the entire operation path by using a plurality of views can avoid the confusion in the view shown in FIG. 2, that is, can avoid, as far as possible, passing through some nodes or links in one view plural times and adding jump paths in the view, thereby clearly presenting operation paths of the respective virtual instances and operation paths between the virtual instances.

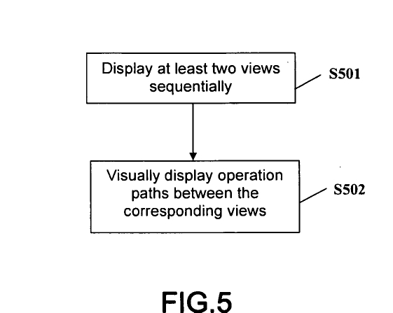

FIG. 5 shows the flow diagram of the display method according to the present invention. As shown in FIG. 5, in step S501, at least two virtual instance views of a process are displayed in a temporal order, wherein each virtual instance view presents at least part of the operation path of the process. Then, in Step S502, operation paths between these virtual instances are visually displayed between the adjacent virtual instance views.

Preferably, in order to completely present the operation path of a process, the operation path of a process is divided into at least two virtual instances. Moreover, in order to avoid the confusion in the view shown in FIG. 2, the method of displaying operation path according to the present invention preferably provides that, when dividing the operation path of a process into at least two virtual instances, each virtual instance shall not contain any dynamic operation, that is, the dynamic operations only take place between two virtual instances. As above described, the dynamic operations include dynamic operations at work nodes, and can preferably further include dynamic operations at judgment nodes.

Preferably based on the predetermined course of a process (i.e. the flow diagram, which is also hereinafter referred to as the monitoring model of a process), a virtual instance view generated presents the operation path of the corresponding virtual instance, i.e. a starting node, a terminating node, possible intermediate nodes, and operation links therebetween of the corresponding virtual instance, so as to provide a comprehensive presentation of the predetermined course and the actual operation path of the process.

As for the virtual instance view presenting the operation path of the corresponding virtual instance based on the monitoring model of the process, it is possible to only display in the virtual instance view those nodes and links concerned by the corresponding virtual instance in the monitoring model. However, preferably, it is also possible to completely display the complete monitoring model in each virtual instance view and to enhanced-present the operation path of the corresponding virtual instance in the displayed monitoring model, i.e. those nodes and links concerned by the corresponding virtual instance. For example, it is possible to enhanced-present the operation path of a virtual instance in the monitoring model by changing the display states of the relevant nodes and links, for example, by bold display, by highlight display, by shade display, and by changing display color, etc.

Preferably, the operation path of a process are divided into virtual instances based on dynamic operations, namely, the operation paths between any two adjacent virtual instances are dynamic operations. However, this is not essential, but the operation path of a process can be divided based on other predetermined rules. For example, it is possible to specify that the division of the operation path of a process is performed upon reaching a certain node, no matter whether that node performs dynamic operations or non-dynamic operations. According to the present invention, preferably, it is possible to merely assure that dynamic operations occurring in the operation path of a process are not contained in any one virtual instance, but they may only occur between two adjacent virtual instances.

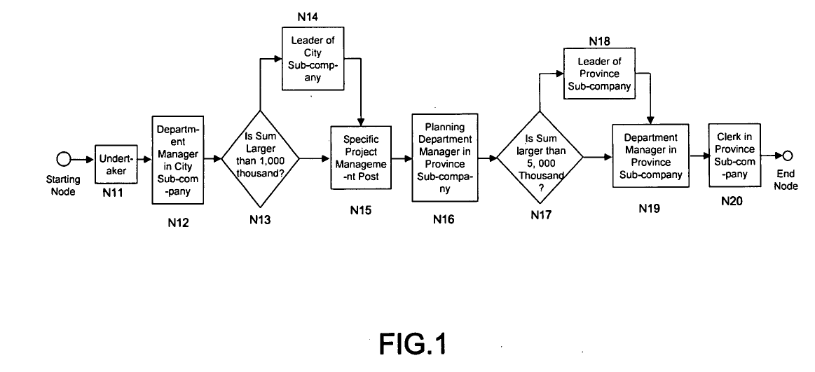

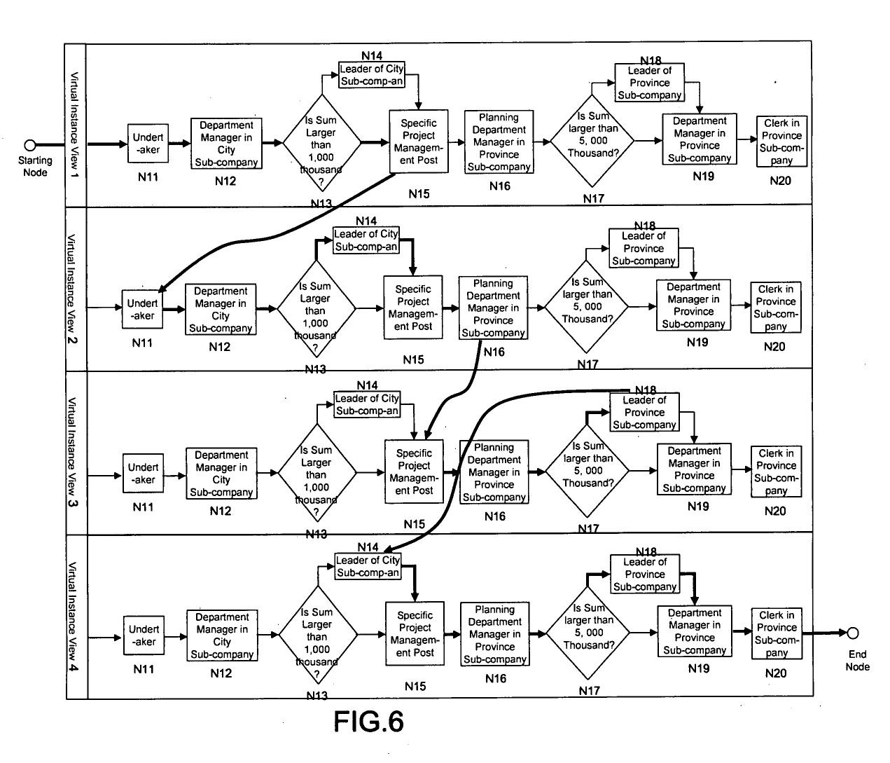

FIG. 6 shows, by taking the business process shown in FIG. 1 as example, the process operation path displayed according to the present invention. As shown in FIG. 6, the entire operation path shown in FIG. 2 are displayed by using four views, wherein View 1 shows the operation path of a first virtual instance, i.e. the running course from Node N11 “Undertaker” to Node N15 “Specific Project Management Post”, and Views 2-4 show subsequent running courses, respectively. Further, between these views, operational relations between the corresponding instances are visually displayed.

In the example shown in FIG. 6, the operation path of the process is divided by dynamic operations. In the example of FIG. 6, the operation path of the process is divided into four virtual instances by using the three dynamic operations shown by the dashed lines in FIG. 2. The first dynamic operation, i.e. the specific project Management Post asking the undertaker to modify the sum of money, takes place between the first and second virtual instances; the second dynamic operation, i.e. the planning department manager in province sub-company asking the specific project management post to modify data, takes place between the second and third virtual instances; the third dynamic operation, i.e. the leader of province sub-company asking the leader of city sub-company to modify data, takes place between the third and fourth virtual instances.

According to the present invention, four virtual instance views (a first virtual instance view, a second virtual instance view, a third virtual instance view, and a fourth virtual instance view) are displayed in a temporal order, wherein the first virtual instance view presents the operation path of the first virtual instance, the second virtual instance view presents the operation path of the second virtual instance, the third virtual instance view presents the operation path of the third virtual instance, and the fourth virtual instance view presents the operation path of the fourth virtual instance. Thus, in each virtual instance view, the nodes and links associated with the corresponding virtual instance in the monitoring model (flow diagram) of the process are presented, and between the adjacent virtual instance views, the operation paths between the corresponding virtual instances are visually displayed, e.g. the above-mentioned three dynamic operations (links) in the example of FIG. 6. In the example shown in FIG. 6, the operation paths of the virtual instances are presented by means of bold display.

In the example of FIG. 6, between the adjacent virtual instance views, the starting node and the terminating node of the dynamic operation between the corresponding virtual instances are connected, that is, the node “Specific Project Management Post” in the first virtual instance view and the node “Undertaker” in the second virtual instance view are connected, the node “Planning Department Manager in Province Sub-company” in the second virtual instance view and the node “Specific Project Management Post” in the third virtual instance view are connected, and the node “Leader of Province Sub-company” in the third virtual instance view and the node “Leader of City Sub-company” in the fourth virtual instance view are connected.

In the example of FIG. 6, the operation path of the each virtual instance is presented in respective virtual instance view based on the flow diagram by displaying the entire monitoring mode (flow diagram) of the process and changing the display states (implemented by bold display in FIG. 6) of the nodes and links associated with the corresponding virtual instance in the monitoring model. However, those skilled in the art can understand that, it is also possible for each virtual instance view not to display the entire monitoring model of the process, but only display the operation path associated with the corresponding virtual instance in the monitoring model.

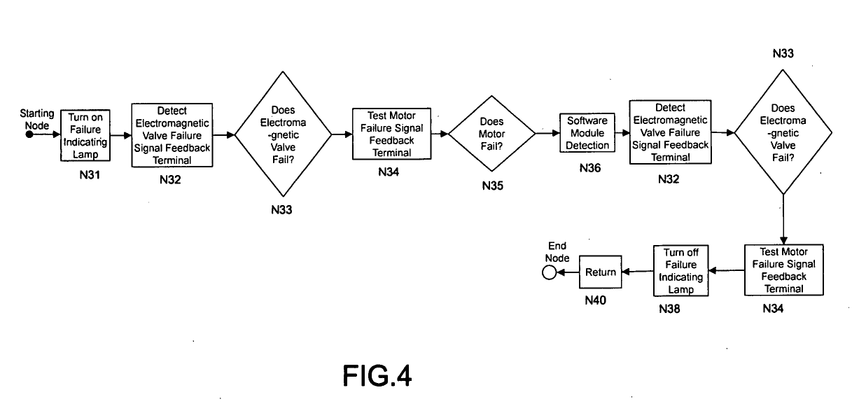

By comparing FIG. 6 with FIG. 2 and FIG. 4, it can be seen that the display method according to the present invention can display the process operation path in a clearer and more intuitive manner, so as to provide the user with better tracking and displaying views.

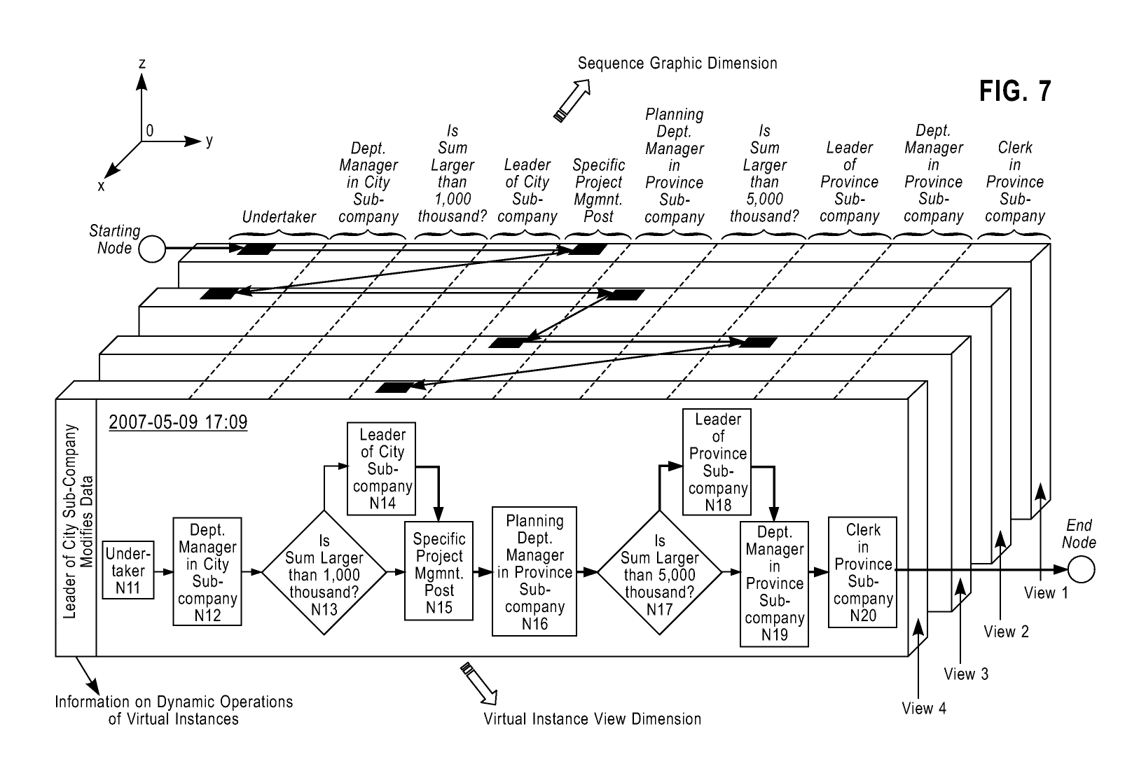

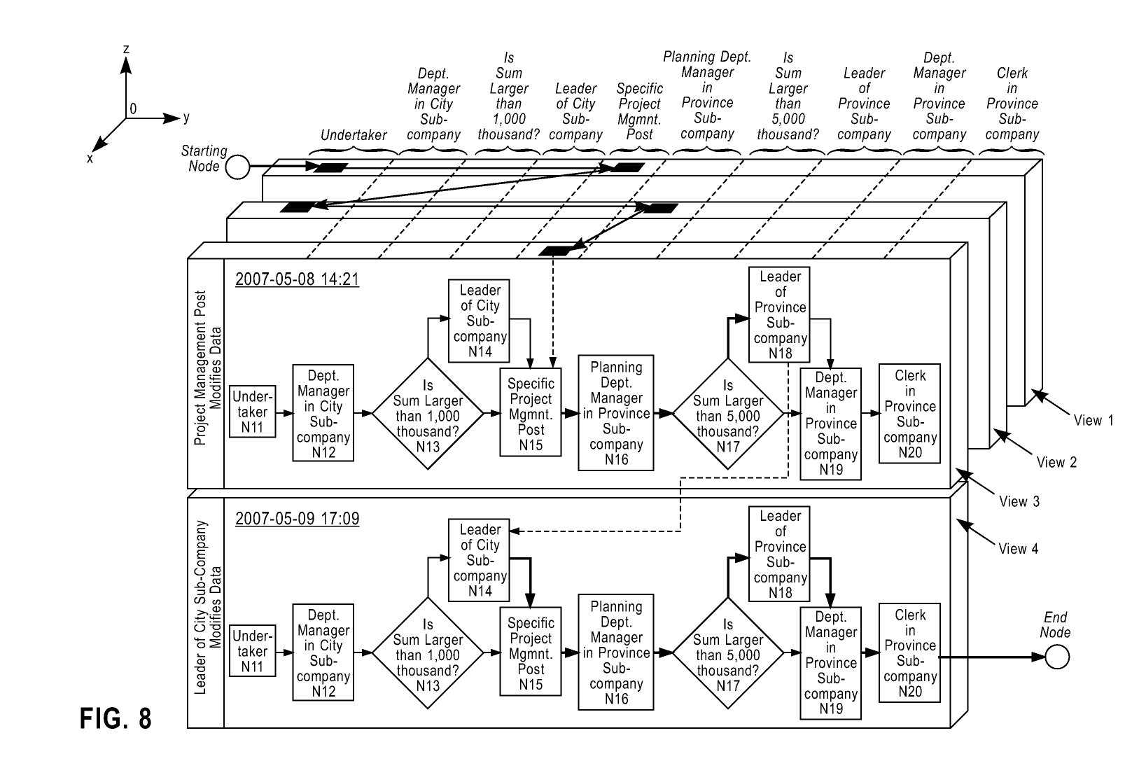

Preferably, in order to better display the process operation path, it is possible to display the plurality of virtual instance views generated in three dimensions, as shown in FIGS. 7 to 8.

FIG. 7 shows, by taking the four virtual instance views shown in FIG. 6 as example, the three-dimensional display of these virtual instance views in a collapsed state. In the display view shown in FIG. 7, the plurality of virtual instance views generated are displayed in three dimensions, wherein the generated virtual instance views are collapsed in a temporal order. A virtual instance view dimension parallel to the view plane (y-z plane in the example shown in FIG. 7) is used to show operation paths of the virtual instances displayed in the virtual instance view. Since the virtual instance views are in the collapsed state, the foremost virtual instance view in the direction of x axis is displayed in the virtual instance view dimension, and other virtual instance views are blocked by the preceding virtual instance view and not displayed. In the collapsed state, the ridge plane parallel to the forward direction of the flow diagram in the virtual instance view dimension (y direction in the example shown in FIG. 7) constitutes the sequence graphic dimension of the three-dimensionally displayed virtual instance views. In the example shown in FIG. 7, the sequence graphic dimension is parallel to x-y plane.

In the sequence graphic dimension, the sequence graphic dimension is divided in the forward direction (y direction) of the flow diagram in the virtual instance view dimension sequentially in a manner correspondingly to the nodes in the complete flow diagram, into segments which correspond to the nodes in the complete flow diagram respectively, and each segment is marked with the name of the corresponding node. Moreover, the nodes of the process operation paths presented in the virtual instance views are aligned with the corresponding segments in the sequence graphic dimension. The operation paths inside the virtual instances, of which the virtual instance views are blocked and cannot be displayed in the virtual instance view dimension, are displayed in the sequence graphic dimension. For example, it is possible to display the operation paths inside the corresponding virtual instances by connecting, by straight lines with arrow, two segments corresponding to the starting node and the terminating node of the corresponding virtual instances on the ridge planes of the rear virtual instance views blocked in the collapsed state. Naturally, it is also possible to display the operation paths of the virtual instances in the sequence graphic dimension by means of highlight display, shade display, changing display color and the like. Furthermore, the operational relations between the adjacent virtual instances are visually displayed in the sequence graphic dimension. For example, between the ridge planes of the adjacent virtual instance views, the operational relations between the corresponding virtual instances are displayed by using straight lines with arrow, that is, the terminating node of the corresponding virtual instance shown in the preceding virtual instance view is connected to the starting node of the corresponding virtual instance shown in the subsequent virtual instance view.

In the three-dimensional display shown in FIG. 7, four virtual instance views are arranged from the rear to the front along the x axis in the temporal order from the early to the late, that is, the foremost virtual instance view 4 displayed in FIG. 7 corresponds to the virtual instance latest in time, while the virtual instance view 1 blocked by the preceding three virtual instance views represents the virtual instance earliest in time.

In the three-dimensional display shown in FIG. 7, the virtual instance view 4 corresponding to the virtual instance latest in time is shown in the virtual instance view dimension, while the virtual instance views 1-3 of the virtual instances preceding it in time are blocked, namely, the operation paths of these three virtual instances are not displayed in the virtual instance view dimension. The operation paths of those virtual instances whose virtual instance views are blocked in the collapsed state are displayed in the sequence graphic dimension. As shown in FIG. 7, on the ridge plane of the virtual instance view 1 earliest in time, the segments corresponding to the nodes “Undertaker” and “Specific Project Management Post” in the flow diagram respectively are connected by using straight line to present the operation path of the corresponding virtual instance. Likewise, on the ridge planes of two virtual instance views 2 and 3 in the middle, the operation paths thereof are also correspondingly presented.

Furthermore, in the sequence graphic dimension, the operation paths between the corresponding virtual instances are visually displayed between the ridge planes of the adjacent virtual instance views. In the three-dimensional display shown in FIG. 7, between the ridge planes of the two adjacent virtual instance views in the sequence graphic dimension, the segment corresponding to the terminating node of the corresponding virtual instance in the ridge plane of the virtual instance view early in time and the segment corresponding to the starting node of the corresponding virtual instance in the ridge plane of the virtual instance view late in time are connected, thereby to display the operation path between the adjacent virtual instances.

For instance, as shown in FIG. 7, between the virtual instance views 1 and 2 in the sequence graphic dimension, the straight line with arrow between the segment corresponding to the node N15 “Specific Project Management Post” on the ridge plane of the view 1 and the segment corresponding to the node N11 “Undertaker” on the ridge plane of the view 2 displays the operation path between the virtual instances 1 and 2. Likewise, the operation path between the virtual instance views 2 and 3 and the operation path between the virtual instance views 3 and 4 are also visually displayed in the sequence graphic dimension.

Besides displaying in the collapsed state, in the three-dimensional display of the virtual instance views, one or more virtual instance views can be spread so that the spread virtual instance views are presented in the virtual instance view dimension. When one or more virtual instance views are spread, the virtual instance views blocking the spread virtual instance views in the collapsed state are shifted by a corresponding offset in the virtual instance view dimension and/or in the sequence graphic dimension without changing the original collapsed state, thereby providing the spread virtual instance views with sufficient space as the virtual instance view dimension.

If a selection is made to spread more than one sequential virtual instance views, the spread virtual instance views are arranged in a same virtual instance view dimension in a temporal order. In the case where a plurality of sequential virtual instance views are spread, the operation paths between the virtual instances corresponding to the spread virtual instance views are visually displayed between the adjacent virtual instance views in the virtual instance view dimension.

FIG. 8 shows a display view in which the virtual instance views 3 and 4 in the display view shown in FIG. 7 are spread. As shown in FIG. 8, the virtual instance views 3 and 4 are spread. The two virtual instance views 3 and 4 spread are displayed in the virtual instance view dimension, that is, the operation paths of the corresponding two virtual instances are presented in the virtual instance view dimension. Furthermore, the operation path between the virtual instances corresponding to the two virtual instance views 3 and 4 spread is visually displayed in the virtual instance view dimension. In the example shown in FIG. 8, dashed lines in the virtual instance view dimension display the operation paths between the virtual instances corresponding to the two virtual instance views spread, and those skilled in the art can understand that the dashed lines in FIG. 8 can also be replaced by real lines or other representing methods.

In the case of dividing virtual instances by dynamic operations, preferably, it is possible to add annotation in each virtual instance view in the virtual instance view dimension to display information on the dynamic operations of the corresponding virtual instance.

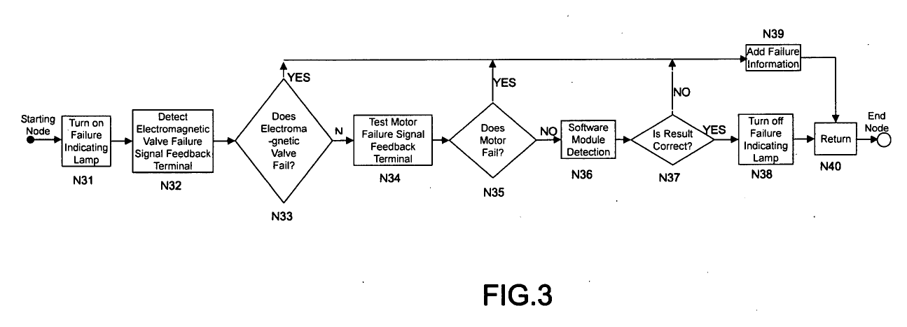

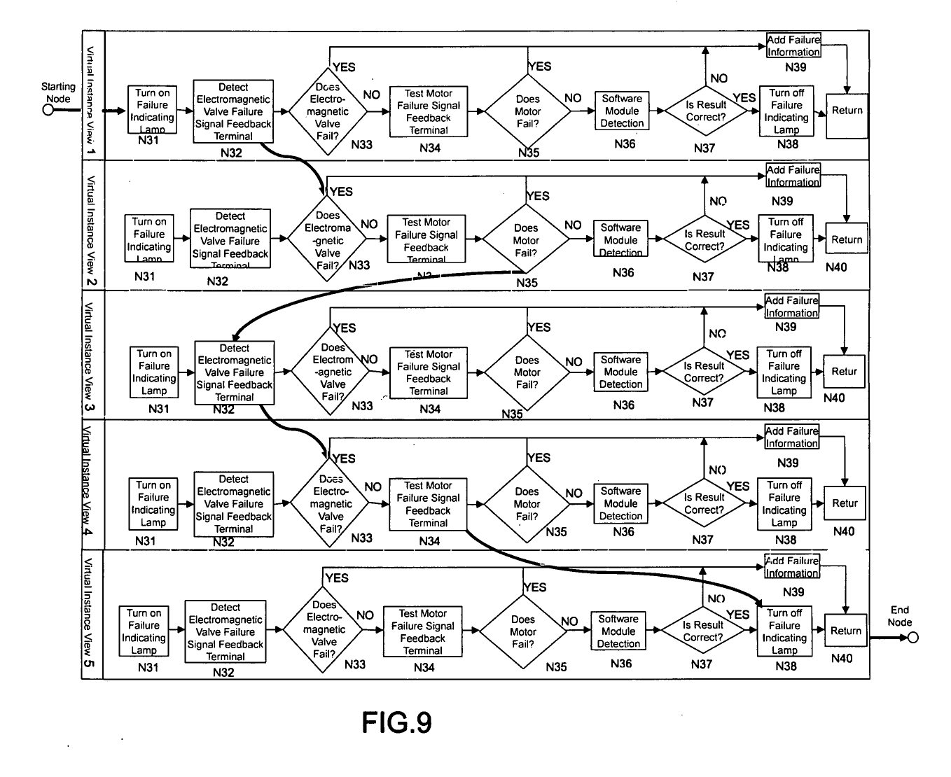

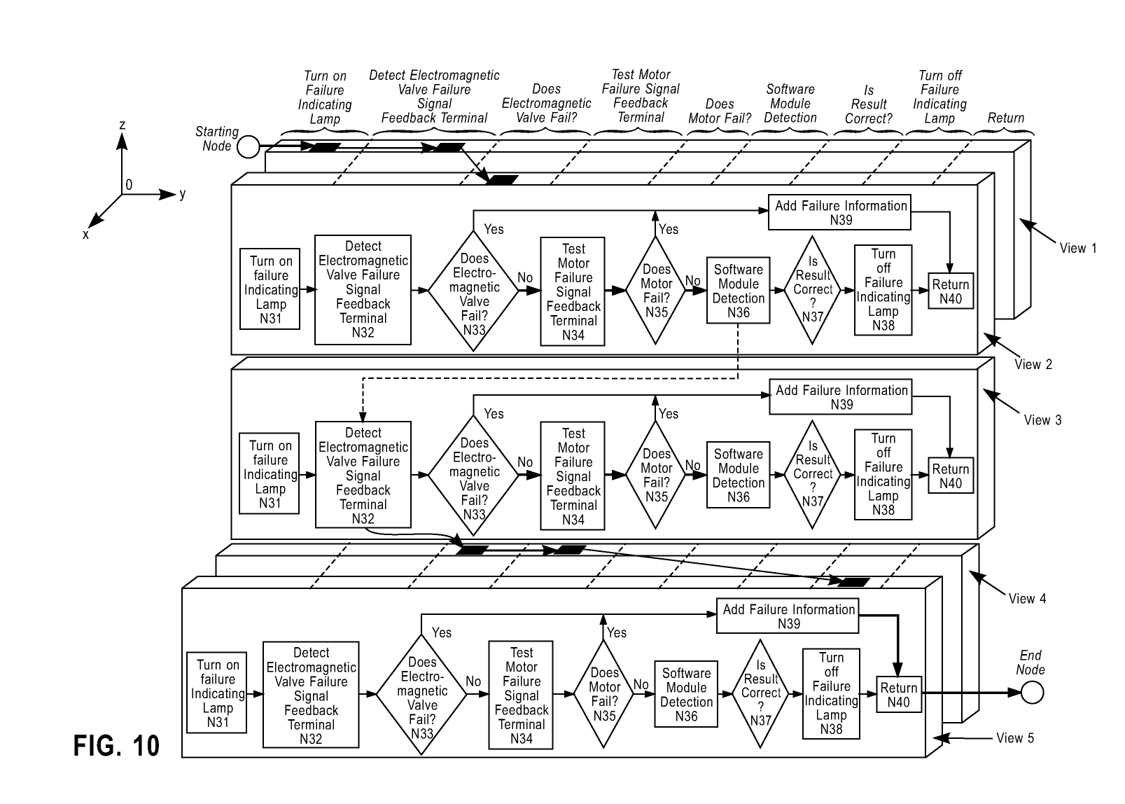

FIG. 9 and FIG. 10 show the operation path of a process displayed according to the present invention by taking the control process shown in FIG. 3 as example, wherein FIG. 9 displays it in two dimensions and FIG. 10 displays it in three dimensions. In the example shown in FIG. 9 and FIG. 10, the operation path shown in FIG. 4 is divided into five virtual instances, that is, the operation path of the process is divided by using two dynamic operations (the operation from Node N36 “Software Module Detection” to Node N32 “Detect Electromagnetic Valve Failure Signal Feedback Terminal” and the operation from Node N34 “Detect Motor Failure Signal Feedback Terminal” to Node N38 “Extinguish Failure Indicating Lamp”) and the operation performed by Node N32 “Detect Electromagnetic Valve Failure Signal Feedback Terminal”, wherein the operation performed by Node N32 “Detect Electromagnetic Valve Failure Signal Feedback Terminal” is not a dynamic operation. However, in the example shown in FIG. 9, it is prescribed that the division of the process operation path is performed to generate a new virtual instance upon reaching Node N32, no matter whether it performs a dynamic operation or a non-dynamic operation. Thus, according to the present invention, the division of the process operation path can be artificially set. In the three-dimensional display manner shown in FIG. 10, the case where the virtual instance views 2 and 3 out of the five virtual instance views are spread is shown.

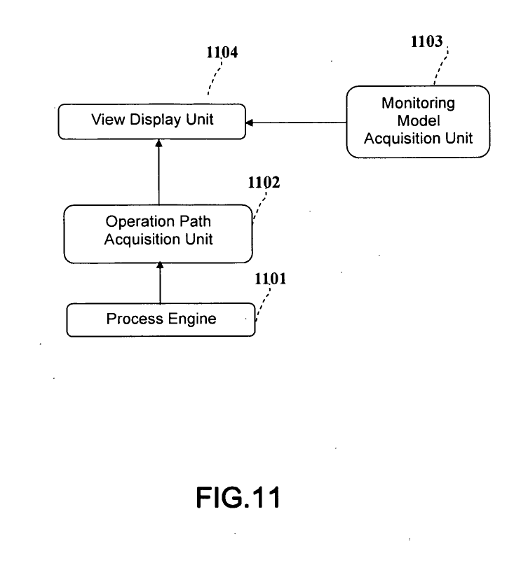

FIG. 11 shows a function block diagram for dynamically displaying the actual operation path of a process according to the present invention. As shown in FIG. 11, the process is running in a process engine 1101, and an operation path acquisition unit 1102 monitors and extracts the operation path of a process in runtime by accessing an API or other interfaces of the process engine 1101, and provides the acquired operation path of the process to a view display unit 1104. A monitoring model acquisition unit 1103 provides the view display unit 1104 with a monitoring model (i.e. flow diagram). The view display unit 1104 displays the operation path of the process by using the method of displaying the process operation path according to the present invention.

The view display unit 1104 can perform the method as illustrated in FIG. 5, so as to display the operation path of a process. In addition, the view display unit can also display dynamically the operation path of a process, in which the view display unit 1104 generates dynamically the virtual instance view by using the recognized operation, so as to present dynamically each virtual instance and the jump operations therebetween.

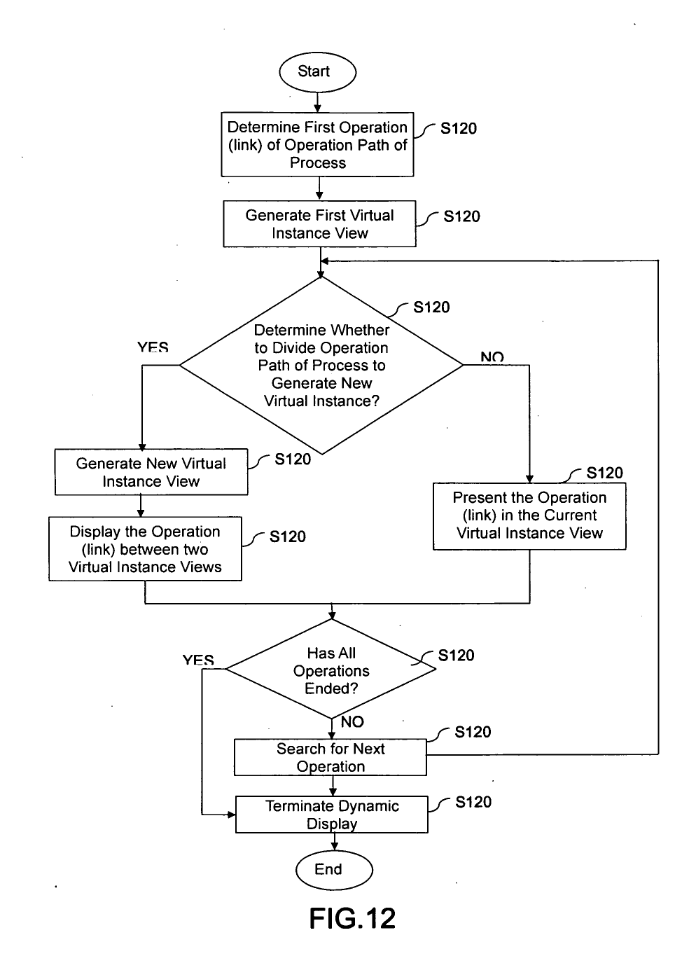

FIG. 12 shows a method executed by the view display unit 1104 when performing a dynamic display. As shown in FIG. 12, in step S1201, a first operation (link) of the process operation path is first determined. Then, in step S1202, a first virtual instance view is generated and the starting node of the first operation (link) determined is presented in the view. In step S1203, it is determined whether the operation (link) complies with the predetermined rule for dividing the process operation path. If it complies with the predetermined rule, a new virtual instance view is generated and the target node of the operation is presented in the new virtual instance view generated, and the operation (link) is visually displayed between the current virtual instance view and the new virtual instance view generated (steps S1204 and S1205). On the contrary, if the operation (link) does not comply with the predetermined rule, the operation (path) continues to be presented in the current view in step S1206. Then, it is determined in step S1207 whether all the operations have been completed. If yes, the method advances to step S1209 to terminate the dynamic display. However, if all the operations have not been completed yet, the method reaches step S1208 to search for and track the next operation and then the method returns to step S1203 to continue dynamic generation and display of the view. As above described, the predetermined rule for dividing the process operation path can either be artificially set or be judging whether the current operation is a dynamic operation.

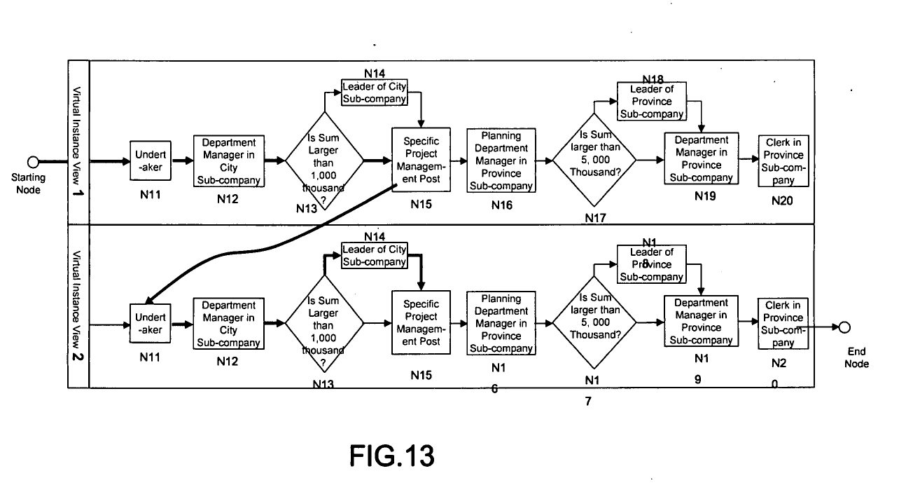

FIG. 13 shows a dynamic display according to the present invention by taking the business process shown in FIG. 1 as example. FIG. 13 shows the display result of the business process after the first dynamic operation shown in FIG. 2 (i.e. from Node N15 to Node N11) but before Node N16. The view shown in FIG. 13 is generated as follows: first, a first operation, i.e. the operation from Node N11 “Undertaker” to Node N12 “Leader of City Sub-company”, of the process operation path is determined. A first virtual instance view is generated and the starting node, i.e. N11, of the first operation is presented in the view, Then, it is determined that the first operation does not comply with the predetermined rule of dividing the process operation path (in this case, the first operation is not a dynamic operation) and the first operation is thus presented in the first virtual instance view. Then, it is determined that all the operations have not been completed yet, the next operation is searched and tracked and the above steps of determining the operations and presenting the nodes and operations are performed. Since all the subsequent operations till Node N15 are not dynamic operations, these operations are all presented in the first virtual instance view. Then, it is determined that the operation at Node N15, i.e. the operation from Node N15 to Node N11, is a dynamic operation, and a second virtual instance view is thus generated. The terminating node, i.e. N11, of the current dynamic operation is presented in the second virtual instance view, and the dynamic operation is visually displayed between the first and second virtual instance views. Thereafter, it is determined that all the operations have not been completed yet, and subsequent operations continue to be tracked. The subsequent operations till Node N16 are not dynamic operations, so these operations are presented in the second virtual instance view.

FIG. 13 shows a display view when the operation path of the process has not ended yet, wherein the process just reached Node N16 in the state shown in FIG. 13. Optionally, it is possible to present the current state of the process, i.e. the node which the process just reached, in the virtual instance view so as to display the activity state of the process. For example, the node which the process just reached can be presented by means of flickering display, highlight display, shade display, changing display color or adding a dashed box, etc. The above-mentioned FIG. 6 shows a display view when the whole operation path of the process has completely ended.

The method of tracking and displaying the actual operation path of a process according to the present invention has been described above by way of several specific embodiments. From the above detailed description of the specific embodiments of the invention with reference to the accompanying drawings, it can be seen that the actual operation path of a process can be intuitively and comprehensively displayed by means of the method according to the present invention.

Those skilled in the art will understand that the method of displaying the process operation path according to the present invention can be implemented by using software and/or hardware in any form and a recording medium recording a program which executes the method according to the present invention.

It should be noted that, the above-described modes for implementing the invention are only used for construe the invention but do not constitute the limitation over the invention.

The embodiments of the invention are specifically described with reference to the accompanying drawings, but those skilled in the art can still make various modifications and alternations of the above embodiments without departing from the essence and scope of the invention. Therefore, the scope of the invention is merely defined by the following claims.

That which is claimed is:

1. A method of displaying the operation path of a process, comprising:
a first display step of displaying views of at least two virtual instances of the process in a temporal order, wherein every virtual instance view presents at least part of the operation path of the process; and
a second display step of visually displaying, between the adjacent virtual instance views, operation paths between the at least two virtual instances.

2. The method according to claim 1, wherein the virtual instance views are displayed in two dimensions.

3. The method according to claim 1, wherein the at least two virtual instance views are collapsed displayed in three dimensions, and the operation paths in the virtual instances corresponding to the collapsed virtual instance views and the operation paths between these virtual instances are presented in a sequence graphic dimension formed by ridge planes of the collapsed virtual instance views.

4. The method according to claim 3, wherein in the direction of the operation path of the process in the virtual instance views, the sequence graphic dimension is divided sequentially into segments corresponding to nodes in the monitoring model, and the nodes of the operation path of the process presented in the virtual instance views are aligned with the corresponding segments in the sequence graphic dimension.

5. The method according to claim 3, wherein one or more of the virtual instance views are spread displayed, the operation paths between the spread virtual instance views are visually displayed in a virtual instance view dimension showing the virtual instance views, and the operation path between a spread virtual instance view and its neighboring collapsed virtual instance view is visually displayed in the sequence graphic dimension.

6. The method according to claim 1, further comprising:
a dividing step of dividing the operation path of the process into at least two virtual instances according to a predetermined rule; and
the first display step presenting the operation path of the respective virtual instance based on the monitoring model of the process, wherein the monitoring model is used to exhibit the predetermined course of the process.

7. The method according to claim 6, further comprising:
a determining step of determining one by one each operation in the operation path of the process; and
a judging step of judging, based on the determined operation, whether to divide the operation path of the process or not;
wherein when said judging step judges to divide the operation path of the process, said dividing step performs division to generate a new virtual instance, said first display step generates a virtual instance view for the new virtual instance generated, and said second display step visually displays between the current virtual instance view and the generated virtual instance view the determined operation; and
wherein when said judging step judges not to divide the operation path of the process, said first display step presents the determined operation in the current virtual instance view.

8. The method according to claim 6, wherein the first display step displays said monitoring model in each virtual instance view and changes display states of nodes and links of the respective virtual instance in the displayed monitoring model to present the operation path of the respective virtual instance.

9. The method according to claim 6, wherein said predetermined rule is to judge whether the operations are dynamic operations or not.

10. The method according to claim 1, wherein the first display step displays the operation path of the virtual instance in at least one of the manners consisting of bold display, highlight display, shade display, and changing display color; and
wherein the second display step displays the operation path between the virtual instances in at least one of the manners consisting of a line with arrow, bold display of the corresponding nodes, highlight display, shade display, and changing display color.

11. An apparatus for displaying the operation path of a process, comprising:
first display means for displaying views of at least two virtual instances of the process in a temporal order, wherein every virtual instance view presents at least part of the operation path of said process; and
second display means for visually displaying, between the adjacent virtual instance views, operation paths between said at least two virtual instances.

12. The apparatus according to claim 11, wherein the first display means displays the virtual instance views in two dimensions.

13. The apparatus according to claim 11, wherein the first display means collapsed displays said at least two virtual instance views in three dimensions, and presents the operation paths in the virtual instances corresponding to the collapsed virtual instance views and the operation paths between these virtual instances in a sequence graphic dimension formed by ridge planes of the collapsed virtual instance views.

14. The apparatus according to claim 13, wherein the first display means divides, in the direction of the operation path of the process in the virtual instance views, the sequence graphic dimension sequentially into segments corresponding to nodes in the monitoring model, the nodes of the operation path of the process presented in the virtual instance views being aligned with the corresponding segments in the sequence graphic dimension.

15. The apparatus according to claim 13, wherein the first display means spread display one or more of the virtual instance views, the operation path between the spread virtual instance views being visually displayed in a virtual instance view dimension showing the virtual instance views, and the operation path between a spread virtual instance view and its neighboring collapsed virtual instance view being visually displayed in the sequence graphic dimension.

16. The apparatus according to claim 11, further comprising:
dividing means for dividing the operation path of the process into at least two virtual instances according to a predetermined rule; and
the first display means presenting the operation paths of the respective virtual instances based on the monitoring model of said process, wherein the monitoring model is used to exhibit the predetermined course of the process.

17. The apparatus according to claim 16, further comprising:
determining means for determining one by one each operation in the operation path of the process; and
judging means for judging, based on the determined operation, whether to divide the operation path of the process or not;
wherein when said judging means judges to divide the operation path of the process, said dividing means performs division to generate a new virtual instance, said first display means generates a virtual instance view for the new virtual instance generated, and said second display means visually displays between the current virtual instance view and the generated virtual instance view the determined operation; and
wherein when said judging means judges not to divide the operation path of the process, said first display means presents the determined operation in the current virtual instance view.

18. The apparatus according to claim 16, wherein the first display means displays said monitoring model in every virtual instance view and changes display states of nodes and links of the respective virtual instance in the displayed monitoring model to present operation path of the respective virtual instance.

19. The apparatus according to claim 16, wherein said predetermined rule is to judge whether the operations are dynamic operations or not.

20. The apparatus according to claim 11, wherein the first display means displays the operation paths of the virtual instances in at least one of the manners consisting of bold display, highlight display, shade display, and changing display color; and
wherein the second display means displays the operation paths between the virtual instances in at least one of the manners consisting of a line with arrow, bold display of the corresponding nodes, highlight display, shade display, and changing display color.

21. A computer program product embodied in computer readable memory comprising:
computer readable program codes coupled to the computer readable memory for displaying the operation path of a process, the computer readable program codes configured to cause the program to:
display views of at least two virtual instances of the process in a temporal order, wherein every virtual instance view presents at least part of the operation path of the process; and
display, between the adjacent virtual instance views, operation paths between the at least two virtual instances.
